(19) United States
(12) Patent Application Publication
(10) Pub. No.: US 2008/0037485 A1
(43) Pub. Date: Feb. 14, 2008

(54) System and Method for Adaptively Controlling a Network of Distributed Devices

(75) Inventors: Anne J. Osinga, Rockanje (NL); Michael S. Holford, Gilbert, AZ (US); Joseph E. Kovach, Brighton, CO (US); Paul F. Josephson, Longmont, CO (US); Jochem Welvaadt, Amsterdam (NL); James Baugh, Denver, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Hunter Douglas Inc., Upper Saddle River, NJ (US)

(21) Appl. No.: 11/572,066

(22) PCT Filed: Jul. 14, 2005
(86) PCT No.: PCT/US05/25290

§ 371 Date: Sep. 10, 2007

(30) Foreign Application Priority Data
Jul. 15, 2004 (US) 60588615
Mar. 18, 2005 (US) 60662959

(51) Int. Cl. H04Q 7/24

(52) U.S. Cl. 370/338

(57) ABSTRACT

The present invention provide apparatus, systems and/or methods for use in controlling a distributed network of main powered devices and battery powered devices. The devices control the operation of one or more appliances. In one embodiment, an adaptive network comprises a main powered device, a battery powered device and a network control device. The network uses a wireless network protocol that includes at least one of a group, network, unit, group flag, mood and/or mask identifier. The network may include a data storage device having a data structure comprising a listing of at least one battery powered device with which the main powered device can communicate on the network, and/or a connectivity rating and ranking of networked devices. The network may also include: a network traffic manager, a routing and a controller identifier.

### CROSS-REFERENCE TO RELATED APPLICATIONS

This application claims the subject matter of U.S. provisional application No. 60/588,615, filed 15 Jul. 2004, and U.S. provisional application No. 60/662,959, filed 18 Mar. 2005. Each of the above-referenced patent applications is hereby incorporated by reference in their entirety as both are fully disclosed herein.

### THE INVENTIVE FIELD

The various embodiments of the present invention relate to wireless automation systems. More specifically, apparatus, processes, systems and methods for using a controller to control one or more battery powered and/or line powered devices is provided.

### BACKGROUND

Systems for controlling devices distributed throughout an office building, factory, home or other location have become desirable over the past several years. Such systems commonly utilize one or more centralized controllers to directly control the operation and functions of one or more networked devices. The networked devices are used to control one or more appliances (i.e., lights, shades, fire sensors, audio/visual equipment, security systems and others). Further, repeaters, amplifiers, remote control devices and other components can be utilized in the system to create a network of devices that desirably can be controlled from any location, at any time.

However, many implementations for home/office automation systems require the control of devices located where line power and/or control is impractical and/or infeasible. Thus, such devices must rely upon batteries and/or other non-line power sources for power. Likewise, such devices must rely upon radio frequency (RF) communications signals for status and control purposes. Thus, automation systems today commonly utilize a combination of line-powered and/or line controlled devices, as well as battery powered/RF controlled devices.

The capabilities, reliability, redundancy and ultimate desirability of such an automation system (from a control perspective) is commonly dependent upon the operating range of any RF transmitter/receiver (a transceiver), how often the transceiver is required to communicate information and/or process received information, and the size of the messages received/transmitted by the device.

Regarding the operating range of the device, currently various systems have been developed which seek to expand the effective reception/transmission range of any device. Such systems can utilize some or all devices within a system as repeaters and/or amplifiers. One such system is described in U.S. Pat. No. 6,856,236, the entire contents of which are incorporated by reference herein.

Similarly, systems have been developed which address how often a device is required to receive, process and/or transmit communications signals. One approach for limiting transmission requirements of devices (as well as controllers) is to utilized adaptive control and/or routing tables which identify to which other devices a given device can efficiently communicate. One use of a routing table is described in U.S. Pat. No. 6,879,806, the entire contents of which are incorporated herein by reference.

Likewise, systems and efforts may utilize communications protocols that minimize the size of data packets needed to be transmitted between devices and/or controllers. Examples of such a protocol are described in the afore mentioned U.S. patents.

While the above mentioned systems are noted improvements over prior systems, additional improvements are necessary to make automation systems, robust, reliable, energy efficient and flexible. The various embodiments of the present invention address such issues by providing a new and innovative automation system.

### SUMMARY

The various embodiments of the present invention provide an automation system that desirably operates in both the wired and RF communications domains as well as in line (or main) and/or battery powered implementations. Desirably, such automation system utilizes a communications protocol that minimizes communication messages so as to reduce the energy demands upon battery operated devices.

In one embodiment of the present invention, an adaptive network is provided which includes a main powered device, a battery powered device and a network control device. This network is configured, for this embodiment, so that the main powered device, battery powered device and network control device communicate using a wireless network protocol comprising no more than 11 bytes of data. Further, such embodiment can also be configured such that a network protocol includes a group identifier and/or a network identifier. Additionally, the protocol may be further configured to include a unit identifier, associated with any of the network components, a second group identifier and other identifiers—as desired. Thus, it is to be appreciated that the network protocol is flexible and responsive to network addressing and identification needs. Further, this first embodiment and/or other embodiments may be configured such that an identifier, such as a second group identifier, includes and/or utilizes one or more group flags, a mood identifiers, mask identifiers and the like. Thus, one should appreciate that devices and network components may be identified and communications therewith using a network protocol that supports common and individualized communications.

In one embodiment of the present invention, a main powered device is provided. Such device can include a central processing unit, processor, microcontroller, reduced instruction controller or other processing and/or control devices. The main powered device may also include one or more network communications interfaces. Such interface(s) facilitating communications connectivity with any number and/or type of communications networks. Likewise, the main powered device may include a device hardware interface, such as a device driver and associated control routines. Practically any device desired to be controlled via the network may be connected to an embodiment of the adaptive networks (and related devices) of the present invention. Data storage and/or memory devices, (collectively “storage devices”), may be used internally or externally to a device. Such storage devices can be configured to include one or more data structures containing data and/or instructions. One such data structure may include a listing of at least one battery powered device with which the main powered device can communicate via an adaptive network embodiment of the present invention.

Similarly, a data structure may include a ranking of devices on the network based, for example, upon a connectivity rating, battery power remaining or practically any other parameter. In one particular embodiment, the connectivity rating can be determined utilizing a counter algorithm. Of course, other routines may also be used to determine connectivity ratings and other parameters. In one particular embodiment of a counter algorithm, an increasing a connectivity rating for a given device may be determined whenever more status messages are received by a main powered device from the given device that exceeds a number of decrement pulses within a given period of time. While the decrement pulse may be generated, received and/or processed on any desired frequency (if any), in one embodiment a decrement pulse is generated approximately once about every 200 mSec.

Connectivity ratings and other parameters are not limited to device-to-device measurements. For example, a main powered device can be compatible with a second data structure comprising a connectivity rating between a second main powered device and at least one other device on the network. More particularly, for such an embodiment, the main powered device and the second main powered device can both be configured (with software and hardware) to include a connectivity rating with respect to a given battery powered device, and the device with the highest connectivity rating is utilized to communicate network messages to the given battery powered device.

In addition to ratings and other inter-device specifications, the various embodiments of the present invention may also be configured to utilize in, desirably but not necessarily, a main powered device which includes the necessary software and hardware to provide a network traffic manager. The network traffic manager may be configured to monitor and/or adjust the message traffic generated by at least one device on the network or even on one or more data channels on one or more networks. Further, the network traffic manager can be utilized to determine and establish redundant communications connections between main powered devices, battery powered devices and network control devices.

In another embodiment of the present invention, an adaptive network can be configured so that devices connected thereto are adapted to operate in at least one of a mono-receive or duo-receive (“duoceive”) mode wherein during duoceive mode a first data channel is utilized to communicate device status messages and a second data channel is utilized to communicate commands between devices.

Various other embodiments of the present invention may be configured to also include repeaters. In such an embodiment, one or more network control devices can be configured to utilize a routing table to determine which repeaters to utilize to establish a communications connection between any given network control device and at least one or more main powered devices and/or battery powered devices. Further, such network control devices can be associated with a controller identifier, wherein the controller identifier is used by a main powered device to determine whether a given network control device is permitted to control the main powered device. Additionally, at least one of the main powered device and the battery powered device can be configured to include one or more device drivers; wherein the device driver(s) can be utilized to control the operation of at least one appliance. The appliance can be practically any device and include, but are not limited to, window coverings, alarm systems, home automation systems, entertainment systems and the like.

The follow description of the drawing figures, detailed description and claims set forth additional features and functions of the various embodiments of the present invention.

### DESCRIPTION OF THE DRAWING FIGURES

FIG. 1 is a schematic diagram illustrating one embodiment of a network configuration of the present invention.

FIG. 2 is a schematic diagram of one embodiment of a control device utilized in the present invention.

FIG. 3 is a flow diagram illustrating one embodiment of a process routine implemented by a main or line powered device (“MOD”) in one embodiment of the present invention.

FIG. 4 is a flow diagram illustrating one embodiment of a process routine implemented by a MOD when receiving a data packet from another MOD on a network embodiment of the present invention.

FIG. 5 is a flow diagram illustrating one embodiment of a process routine implemented by a MOD when receiving a data packet from a network control device (“NCD”) on a network embodiment of the present invention.

FIG. 6 is a flow diagram illustrating one embodiment of a process routine implemented by a MOD when receiving a data packet from a battery powered device (“BOD”) on a network embodiment of the present invention.

FIG. 7 is a flow diagram illustrating one embodiment of a process routine implemented by a BOD when receiving a data packet over a network embodiment of the present invention.

FIG. 8 is a flow diagram illustrating one embodiment of a process routine implemented by an NCD on a network embodiment of the present invention.

### DETAILED DESCRIPTION

The various embodiments of the present invention provide systems and methods for utilizing one or more communications mediums to communicate propagated signals used in adaptively controlling a network of distributed devices. In one particular embodiment of the present invention, radio frequency (RF) communications are utilized to facilitate the communication of control, status and other information signals between a plurality of devices which form the network. In other embodiments of the present invention, RF, optical and/or other communications mediums and signal can be utilized.

System Overview

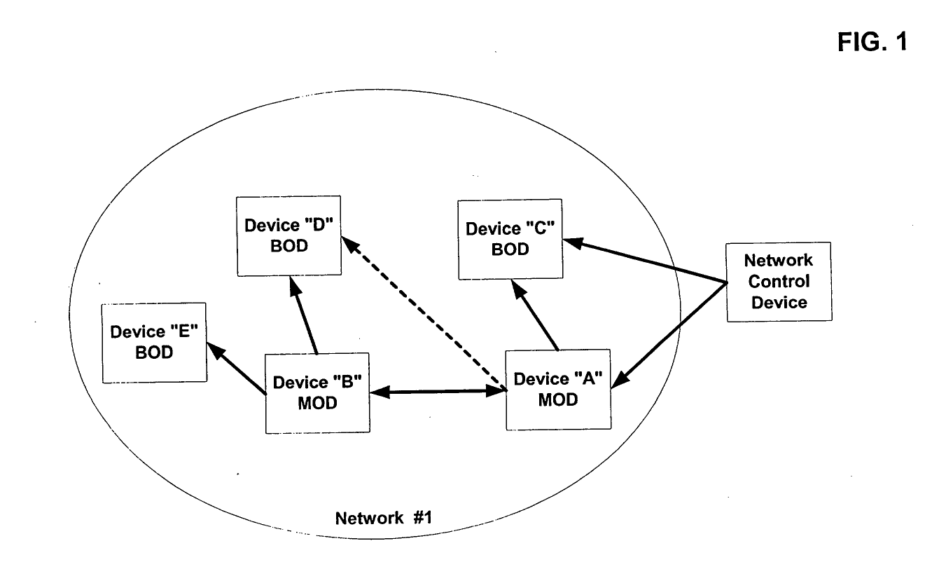

As shown in FIG. 1, one embodiment of the present invention provides for command and control of a plurality of distributed devices (A-D) associated with a network. The network can range from including as few as two devices to as many as 65,000 (or more) devices. Further, the network “devices” can be associated with, part of, separate from and/or identified as network “nodes,” as appropriate. Command, control, status and other message signals are desirably communicated amongst the devices on the network either directly or indirectly. It is to be appreciated that whether direct or indirect message passing occurs within a network commonly depends upon device and/or network specific characteristics and configurations. For example, star, hub and spoke, point-to-point, distributed, peer-to-peer, mesh, partial mesh, ad hoc, mobile, hybrids and/or combinations thereof, and other network design(s) can be utilized in the various embodiments of the present invention to facilitate communications and the propagation of signals between networked devices. Also, a device can be used in a stand-alone mode, where it is not networked with any other devices (for example, a garage door opener can be used in a stand-alone mode). Similarly, certain devices can be configured to receive, relay, repeat, amplify and/or transmit messages of a specific type, size, content or otherwise, while not being configured to receive, relay, repeat, amplify and/or transmit other messages. Further, various communications mediums, both wired and non-wired, can be utilized in the various embodiments of the present invention. Again, the use of a particular communications medium can be dependent upon device, network and/or other external factors, such as the availability of spectrum (in the case of RF mediums), whether hard-wired connections exist between devices, the distances between devices, whether a given environment is less or more favorable to a given communications medium, and other factors, many of which can be implementation specific. As such, it is to be appreciated that FIG. 1 provides a high-level representation of one networked system which can be utilized in conjunction with the present invention. Other networked systems can also be accordingly utilized in conjunction with the teachings herein.

As further shown in FIG. 1, an embodiment of the present invention can desirably be configured to interface with non-networked devices. For example, a remote control device can be utilized and can enable a user to remotely command, control or otherwise interface with the network and/or the devices connected to the network. Hard wired control devices, however, can also be utilized, such as those implemented over Ethernet, Internet, LANs, WANs, ATM networks, telephone networks and/or otherwise. Such remote control and/or hard wired control devices can be suitably configured using instructions, data and other content provided via hard-coded structures (e.g., integrated circuits), propagated signals (e.g., those communicated over a wireless, wired, Internet or Ethernet connection), computer readable mediums (e.g., CDs, DVDs and the like) or otherwise. In certain embodiments, the network can also facilitate communications between two or more non-networked devices. In such an embodiment, one or more devices in the network effectively operate as intermediaries to other networked or non-networked devices. The various embodiments of the present invention can also be configured to be compatible with other network technologies, protocols, standards and/or topologies including, for example but not limited to, X-10, LONWORKS from Echelon Corporation of San Jose, Calif., Z-WAVE from Zensys Inc. of Upper Saddle River, N.J., KNX from the Konnex Association, ZIGBEE from the Zigbee Alliance and others.

Various types of devices can also be utilized in conjunction with the present invention. In one particular embodiment, the networked devices can include one or more powered window coverings. Other, non-window covering devices can also be utilized in conjunction with the various embodiments of the present invention such as light fixtures, appliances, security systems, monitoring systems, home automation and control, commercial building monitoring, industrial automation, wireless automated meter reading, chemical and biological monitoring and/or eradication, environmental and habitat monitoring and others. Often, such devices utilize electricity, provided by electrical outlets, to power the device. However, other power sources can also be utilized. Battery, solar, wind, water, and practically any other power source can be utilized by devices in various embodiments of the present invention. In short, the networked (and non-networked) devices utilized are not limited to those hard-wired to an electrical outlet, battery powered or the like, nor are they limited to performing any particular function, provide any specific service or are otherwise so constrained or limited.

In one particular embodiment of the present invention, the network includes a plurality of devices, some of which are main powered devices (“MODs”) (i.e., they are powered from an electrical outlet or other generally non-depletable power source, such as a generator) and others, which are battery or other depletable, non-main powered devices (“BODs”). Herein, BODs shall be defined to refer to any device which receives operating power from a source other than an electrical outlet or other generally non-depletable power source. Such power sources can be expendable, as in the case of non-rechargeable batteries. Similarly, rechargeable and/or non-line power sources can be used in BODs, including those providing power directly and/or in order to recharge a depletable power source such as a battery. Power sources in BODs can further include one or more capacitors which operate separate and/or in conjunction with batteries, solar cells, wind generating sources, fuel cells, and/or other power storage devices. In certain embodiments, BODs can be recharged directly or indirectly, for example, via an electrical outlet, generator, solar energy, fuel cells, wind or otherwise. In any event, for a BOD, operating power is desirably provided by one or more non-line power sources.

Also, certain device embodiments consistent with the teachings of the present invention can be configured to utilize power sources (both line and non-line) on an “as available” or “when present” basis. For example, a device utilizing or responsive to wind speeds can be configured to be “active” and/or “on the network” when the wind speed exceeds any given threshold. Further, a windmill or wind turbine, can be utilized in certain embodiments to power the device when desired. Also, a MOD can functionally operate as a BOD when line power is not available and battery power is being utilized to power the device. Such an occurrence can occur, for example, during a power outage. Thus, depending upon the network configuration, the features, roles and/or capabilities of any given device, and power considerations, the network can adapt and morph in its configuration, as devices enter or exit the network, as line power is or is not available, as certain conditions are or are not present, and otherwise. Thus, an adaptive network, which can be “closed” or “open,” is desirably provided by the various embodiments of the present invention.

The network embodiments of the present invention also generally includes one or more network control devices (“NCDs”). The NCDs, which are discussed in greater detail hereinbelow, can be used to configure and control the network and the operation of devices thereon. NCDs are generally battery powered, but, can also be line or otherwise powered. Thus, many of the power considerations addressed by BODs are also present for NCDs.

The network embodiments of the present invention can also be configured to include one or more devices which function (exclusively or in part) as repeaters. When functioning as a repeater, a device preferably knows which other devices (BODs, MODs and/or NCDs) with which it can communicate. Further, a repeating device is further configured to recognize when it is being requested to function as a repeater.

As further shown in FIG. 1, each MOD, BOD or NCD can establish one or more communications links with other MODs/BODs/NCDs on the network. These links can include non-wired or RF links, wired links, or combinations thereof. Further, each device on the network may not be directly connected to each of the other devices on the network. In such instance, desirably one or more MODs relay communications between respective devices. Likewise, in at least one embodiment of the present invention, BODs desirably do not relay communications between other devices due to power considerations. Thus, it is to be appreciated that any variety of communications links, MODs, BODs and NCDs can be used in the network.

MODs

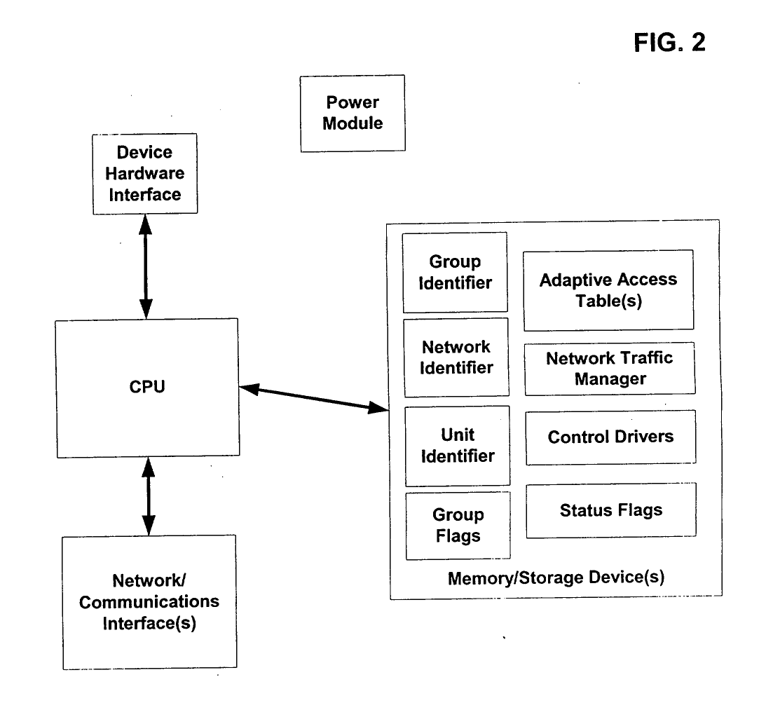

Referring now to FIG. 2, for at least one embodiment of the present invention, MODs provide active network control, management, redundancy and communication functions. In one such embodiment, MODs desirably include a central processing unit (CPU) which is capable of implementing, at least, a given set of instructions utilized to control, configure and/or communicate with one or more devices on the network (such as other MODs, BODs, repeaters and/or NCDs) and with those off or external to the network (such as NCDs, home controllers or the like). It is to be appreciated that NCDs can be considered “on” or “off” the network, at any time, depending upon features and functions provided by NCDs. In certain embodiments, one or more NCDs can function similarly to a MOD, with respect to controlling devices, relaying communications, and the like. In other embodiments, NCD(s) can function more like a BOD, by providing limited communications capabilities and few, if any, device control functions.

The CPU (in a MOD, BOD or NCD) can be configured from any of a wide variety of processing/control devices including micro-processor/micro-controllers with/without flash or other embedded or non-embedded memory. Desirably, the CPU possesses sufficient memory to accomplish any given networking and control tasks. In one embodiment, wherein the HDNET protocol is utilized, 2 Kbytes of memory is desired, whereas in other embodiments 64 Kbytes or more of memory is desired. The HDNET protocol is a communications protocol developed by Hunter Douglas Inc. Under this protocol, a limited communications packet data structure is transmitted between devices and controllers on a network. This limited communications data protocol is further described herein and is optimally designed to minimize power requirements necessary for controlling the network and the devices thereon. However, other embodiments of the present invention can utilize devices compatible with one or more network topologies, such as ZIGBEE.

In one embodiment, the CPU is a MicroChip 16LV876 microprocessor with 8 Kbytes of on-board random access memory (which is represented in FIG. 2 as the memory/storage device). It is to be appreciated, however, that other processors, controllers and similar devices can be used in other embodiments of the present invention to control the features and functions of a MOD. Likewise, additional and/or other memory/storage devices can be used in conjunction with the CPU. Such memory can include RAM, ROM, EPROM, Flash, magnetic storage devices, optical storage devices, molecular storage devices, biological storage devices, fixed and removable devices and the like.

As further shown in FIG. 2, the CPU desirably is indirectly or directly connected to a network/communications interface (NCI). The NCI desirably includes the hardware and software necessary to provide any desired network interface and communications facilities and functions. Common hardware components can include ports, modems, encoder/decoders, compressors/decompressors, transponders, transceivers, transmitters, filters, multiplexers, buffers, receivers, antennas and others. All of which are well known in the art. In one embodiment, a Nordic NRF 2401 transceiver is utilized as the NCI. Such transceiver desirably facilitates the sending and receiving RF messages from other networked devices over a range in excess of 60 meters at a center operating frequency of 2.4 GHz. Other receivers, transmitters and/or transceivers (hereafter collectively, “Xtr(s)”) can be used in conjunction with various embodiments of the present invention. Such Xtrs can operate on one or more frequency bands including the before mentioned 2.4 GHz, 908.42 MHz, 868 MHz, 915 MHz and other “open” bands, where “open” bands commonly refer to those communications bands presently or in the future which have been designated for unlicensed use by the Federal Communications Commission, the European Economic Commission or others. Likewise, Xtrs compatible with licensed communication bands can also be utilized in conjunction with various embodiments of the present invention.

For example, MODs can be configured to be compatible with microwave, satellite, cellular and other communications bands. Likewise, BODs can be similarly configured with the caveat that a trade-off commonly arises between increased communications capabilities and power requirements.

In certain embodiments, such as industrial or residential settings, desirably the transceiver has a range greater than 20 meters. Transceivers with greater and/or lesser ranges can also be utilized, as can transceivers operating on different frequencies. For security and/or message integrity purposes, frequency hopping, spread spectrum, advanced and/or complicated encoding and modulation and other technologies can also be used and/or supported by the NCI.

Further, various communication modulation technologies can be utilized in the various embodiments of the present invention. For example, for embodiments which are compatible with at least the HDNet protocol, ALOHA and/or other random multiple access protocols can be used. For embodiments compatible with at least the ZENSYS or ZIGBEE protocols, Direct Sequence Spread Spectrum (DSSS) and other modulation techniques can be used in an NCI.

Various transmission powers can also be utilized and can range from, for example, approximately −3 dBM to 4 dBM. Desirably, in an HDNet implementation the transmission power of an NCI is approximately −5 dBm. An Xtr is also desirably sensitive to varying communication signal power levels, for example, but not limited to those, ranging from −96 dBm to −85 dBM. The receive sensitivity can depend upon the communication protocol(s) with which any given device is compatible. For example, in an HDNet implementation, desirably, the Xtr has an RF sensitivity approximate to −90 dBM. Likewise, the adjacent channel rejection characteristics of an Xtr can also be device/implementation specific and commonly range from 0 dBM (or less) to 20 dBM (or more) with 20 dBM being the preferred adjacent channel rejection sensitivity of an HDNet compatible implementation. The effective range of any Xtr's output signal can also vary, based upon implementation, from very short ranges (i.e., less than a meter) to relatively long ranges, including those utilizing satellites, microwave and other long-haul communication links. In an embodiment where “open” bandwidths are used for communications, the Xtr supports transmission ranges up to approximately 150 meters, with 60 meters being desirably implemented in HDNet implementations. Further, it is to be appreciated that the range of any Xtr will vary with power available, frequency band, modulation technique(s) and other environmental factors, such as whether the environment is “noisy” and/or whether obstructions exist (e.g., buildings, trees, hills, walls, and the like).

Various transmission powers, durations and frame beacon frequencies can also be used in the various embodiments of an Xtr. In an HDNet implementation, for example, desirably the Xtr transmits signals using 10.5 mA for 128 mS with frame beacons occurring over a range of every 5 mS to 256 mS. In a ZENSYS and/or ZIGBEE implementation (i.e., an NIC that is compatible with at least a ZENSYS and/or a ZIGBEE network), the Xtr desirably transmits signals using up to 34 mA for 250 mS with frame beacons occurring every 60 mS or over the range of every 15.36 mS to 251.66 mS, respectively. Thus, it is to be appreciated that the transmission power, transmission duration and frequency of frame beacons utilized in any given embodiment and/or implementation can vary significantly.

Additionally, the NCI is desirably configured to support multiple communication channels and operate in a duoceive mode. In one particular embodiment of the present invention, a first channel is utilized to communicate update and status messages between the various devices on the network. A second channel, desirably spaced 8 MHz from the first channel, is utilized to communicate commands to those device(s) to be controlled at any given time. In duoceive mode, hardware devices (such as MODs and BODs) can be utilized to simultaneously support network functionality communications (such as status messages and “wake-up” messages) as well as point to point functionality communications (such as command messages). It is to be appreciated that duoceive mode can result in energy savings across the network and, more particularly, in power constrained devices such as BODS. When using duoceive mode the transmitter, processor, NID and other components utilized in a device are desirably in a higher power state for a shorter time period than when network functionality messages and point-to-point functionality messages (or vice versa) are communicated in succession.

In one particular embodiment, BODs utilize duoceive mode to substantially simultaneously transmit “wake-up” messages on a first channel and data traffic using a second channel. It is to be appreciated that the use of duoceive correspondingly results in extending the battery life in power constrained devices, such as BODs.

As mentioned above, the various embodiments of the present invention are not limited to using only RF communications to propagate signals across the network, but RF is preferred for many embodiments. Additional communication mediums can include those provided via practically any wired or non-wired medium, for example, the power line can be used to support communications, X10 devices can be utilized, Bluetooth, IP and others can be used. In one particular embodiment, wireless local area networks (“WLAN”) can be supported. Since WLANs commonly utilize non-standardized frequency hopping techniques, the NCI desirably includes those hardware and software modules necessary to support at least one WLAN implementation. It is to be appreciated that as the number of WLAN and other communication protocols expand, device drivers can be added to the devices on the network, as required to support such protocols. Desirably, the NCI can be configured and/or expanded, as necessary, to support such future and/or alternative communication topologies. Last, it is also to be appreciated that standard PCB, USB, IEEE 1394, serial ports, parallel ports and other common communications interfaces can be included in various embodiments of the NCI.

Just as various hardware components can be utilized in the NCI to facilitate connectivity between one or more devices, a wide variety of software programs and routines (“components”) can be used. Such components can include compression/decompression, algorithms/instructions, encryption/decryption software, various communications protocols, such as TCP, UDP, IP, ATM, CDMA, GSM, variants and/or combinations thereof and others. Various interface protocols, translators and the like can also be utilized. Thus, it is to be appreciated that the NCI can include any number of hardware and software components that enable, support and/or facilitate implementation of various communications topologies, technologies and interfaces, with specific features and functions being utilized in any given embodiment.

Referring still to FIG. 2, as mentioned previously above, each MOD device is desirably connected to one or more sources of line voltage electrical power. Yet, line and non-line power source(s) can also be used in any MOD device. The power module desirably provides any necessary interface and/or conditioning needed to deliver line power from an outlet to the CPU and other control components, such as the NCI, device drivers, memory/storage devices and others.

In certain embodiments, the power module can also provide those power conditioning and/or interfaces needed to drive one or more actuators in the device. For purposes of the present invention, an actuator is any non-control related feature or function of the device. For example, when the device is a powered window covering, the actuator can include a motor and related gearing, cams, and the like which facilitate the raising or lowering of the window covering. Practically any configuration of motorized window coverings can be utilized in conjunction with the systems and methods of the present invention. For purpose of illustration, the motorized window covering disclosed in U.S. patent application Ser. No. 10/732,747, filed on 10 Dec. 2003 in the name of inventors Joseph E. Kovach et al., and entitled “Remote control operating system and support structure for a retractable covering for an architectural opening” (hereafter, the “'747 application”) is incorporated by reference herein in its entirety. Thus, it is to be appreciated that the power module desirably conditions and provides power received from a line power source to the control aspects of a device and, in certain embodiments, device actuators for window coverings.

As discussed above, the various embodiments of the present invention are not limited to controlling window coverings. The various embodiments can also be utilized to control practically any other device, including for example, security systems, HVAC systems, industrial process controls, home automation, commercial facilities monitoring, wireless automated meter reading, environmental and agriculture wireless sensors, and others.

Referring again to FIG. 2, as discussed previously, the CPU desirably includes on-board memory, for example, 64 Kbytes of embedded Flash memory, as can be utilized, for example, in a ZIGBEE compatible implementation of the present invention. Also, off-board or stand-a-lone memory/storage devices (both removable and fixed) can also be utilized. Regardless of whether embedded or separate, sufficient memory/storage is provided for the data necessary for the specific implementation. Such data commonly includes data protocols as well as device specific parameters and/or information. As shown in FIG. 2, such memory can be configured to facilitate the storage and retrieval of information and/or instructions (i.e., “data”) used to control any given MOD as well as to provide network connectivity, status and other information.

In an HDNet and/or Zensys compatible implementation, each device can be identified using three distinct identifiers, which are suitably stored in each MOD. The first of these identifiers is a Group Identifier (“GID”). In at least one embodiment, the GID is a two byte word which provides 65,000+ separate identifications of device groupings.

In one embodiment, the first byte of a GID, is used to identify the manufacturer of the device. Desirably, each manufacturer is assigned a unique, one-byte, identifier and devices compatible with the presently described network are factory (or otherwise) programmed with such identifier. For example, the device can be identified as having been manufactured by manufacturer “A” by setting the first byte to a first value, while another device can be assigned to manufacturer “B” by setting the first byte to a second value. In one embodiment, devices are compatible with only those devices manufactured by the same manufacturer (as identified by the first GID byte).

The second byte in the GID is desirably utilized when programming the device for a particular installation or implementation. For example, a manufacturer, an installer or other person can program the second GID byte for all devices used by company “Y” in building “X” to a first value. Similarly, the second GID byte for devices used by company “Z”, which is also located in building “X”, can be assigned to a second value. Thus, the GID facilitates manufacturer and installation/implementation identification of devices on a network. Desirably, devices with the same GID can communicate with each other and forward messages.

Yet, other derivations and segregations of the GID can be utilized in particular implementations. For example, in certain embodiments, a range of GID values (for example, but not necessarily, those identified by only the first or second byte) can be used to identify a networked device(s) as pertaining to a particular manufacturer and/or installation. Also, cross-compatibility between devices manufactured by various manufacturers can be supported by using standardized GID values (or portions thereof). As such, it is to be appreciated that the GID provides an identifier of at least one of manufacturer and/or installation that any given device is compatible.

In certain embodiments of the present invention, the GID can be augmented and/or replaced by other designators and/or capabilities such as security. It is to be appreciated that PIN based security features, DES, 3DES, Secure Socket Layers, biometrics, and other security technologies can be used in certain embodiments in addition, deletion, augmentation of expansion of the GID. However, as the GID increases in length, so too do the output power requirements because of the simple fact that a larger protocol stack requires more transmission time than a smaller protocol stack. Thus, it is to be appreciated that a trade-off commonly occurs between the size of the protocol stack and battery life in BODs, because the BOD must be “active” longer to process a larger protocol stack. Depending upon the implementation desired, the protocol stack can vary and range from miniscule to greater than 32 kBs of data, with an HDNet implementation residing closer to the former and a ZIGBEE implementation closer to the latter.

Further, a GID can include a designation of two or more devices by a “mood” identifier. In particular, a “mood” can designate a group or sub-group of devices that all have a specific characteristic. For example, all window coverings with a southern exposure can be a “mood” within the larger grouping of “window coverings.” Similarly, the “mood” and/or GID can be used to specify a setting level. For example, a group of window coverings can be set as a mood to specify “full closed” or “50% open,” or the like.

As further shown in FIG. 2, the memory/storage device also commonly includes a data field within which a network identifier (“NID”) is stored. NIDs are desirably two bytes long (but, in other embodiments, can be longer or shorter). NIDs are utilized to identify and further segment and/or partition devices within a given location and/or implementation. More specifically, NIDs can be utilized to identify a device as belonging to any given network within a location (such as a company “Y” facility). While those devices with a given GID will communicate messages to other devices (with the same GID and within range), only those devices with the same NID can be programmed to execute a message designated for a specific network (which, as is discussed in greater detail hereinbelow, can be further segmented in, for example, an HDNet implementation, into groups). For example, the devices in a lunchroom and executive offices in facility can all have the same GID (e.g., the first byte can indicate the manufacturer of the devices is Hunter Douglas and the second byte can indicate the installation is for GE corporate headquarters). Yet, the devices in the lunchroom can be assigned to network “1” or NID=1, while the devices in the executive offices are assigned to network 10 or NID=10. Under such a configuration, messages will be passed amongst those devices with the same GID, but, will only be processed and/or implemented by those with the same NID. Thus, devices located in the lunchroom can be on a first network (and separately controlled) while devices in the executive offices are on a second network (and likewise separately controlled).

Yet, in another embodiment of an HDNet implementation, devices can be assigned to more than one network by using various mathematical combinations of NIDs. For example, the common entry to a building might be assigned the value 127 to indicate multiple networks (such as NID 1, NID 2, NID 4, NID 8 and so forth). Thus, it is to be appreciated that the NIDs desirably identify a single network, but, in certain alternative embodiments can be used to identify any number of networks with which a given device can be associated.

In one embodiment of the present invention, devices are programmed with a NID upon the pressing of a button upon an NCD (e.g., a “remote”). Desirably, a randomly generated NID code is communicated from the remote to the device. The NID code is then stored/programmed in the device's memory/storage device. Under this approach, it is to be appreciated that using one byte of a GID and the two byte NID, 16,640,000 GID/NID combinations are possible.

To further identify individual devices, other than identifying them by a group and a network, unique identifiers (“UIDs”) can also be utilized in the various embodiments of the present invention. UIDs commonly are two bytes in length, and thus are capable of identifying any of 65,000 different devices or device configurations. UIDs are commonly factory set, but, in some embodiments can be configurable as the features and/or functions of a device are modified. Each of these identifiers, GID, NIDs, and UIDs are desirably stored in non-volatile memory devices, many of which are commonly available and well known in the art. Thus, it is to be appreciated that each device desirably includes an identifier of at least one GID, NID and UID.

Further, other embodiments can include repeater identifiers. The communications protocol can be configured to identify specific devices as repeaters by including a separate repeater identifier field. When a device (commonly a MOD, but possibly a BOD or NCD) is identified as a repeater in a communications message, it desirably retransmits the message without itself executing any instructions provided in the message. Desirably, network control tables and routing tables are used, when necessary, to identify repeaters and destinations for messages.

Further, masking of device identifiers can be used to identify which devices in a network are to perform a given action. Specifically, each device in a network can be masked, in a data frame, as a single bit in a device id field. Then upon sending a command, the corresponding device id fields are set for the devices designated to implement the command. Such an embodiment reduces the number of data bits necessary to communicate and specify which devices are to implement a given command. Notably, the masking technique can be applied to device identifiers, repeater identifiers, group identifier and network identifiers, as desired. Further, different masking tables can exist for different controllers, with the different masks to use for any given communication being determined based upon an identification of a sender of the communication. Examples of the use of masking in a communications protocol are set forth in the before mentioned U.S. Pat. No. 6,856,236, entitled “RF Home Automation System Comprising Nodes With Dual Functionality,” which issued in the name of inventors Carlos Mellia Christensen, et al., on 15 Feb. 2005. the contents of which are, again, incorporated by reference herein in their entirety.

The communications protocol utilized in the networks of the present invention can be simplified and power savings desirably achieved during device operation by programming each device to include a second group identifier, such as a setting of one or more programmable and/or hard coded group flags. In one embodiment, 32 group flags are provided. Each device can be assigned to one or many groups. Each group flag desirably corresponds to a given grouping of one or many devices. Each device, when identified by the appropriate GID and NID, responds to commands associated with those group flags to which the device has been previously identified. For example, a meeting room can contain ten different devices. Each device desirably has a unique UID, but a common GID and NID. During programming, each device is associated with one or more groups and the corresponding group flag(s) are set in each device's memory/storage device. For example, group 1 can include devices 1, 3 and 5, group 2 can include devices 2, 4 and 6 and group 3 can include all ten devices. Depending upon the desired groupings, a user can control any combination of the devices using the NCD. When group 1 is selected on the NCD, the command is processed by only those devices which have previously been assigned to group 1. Group 2 devices (i.e., devices 2, 4 and 6 in this example), would not respond to the Group 1 command. As such, it is also to be appreciated that the use of groupings facilitates efficient communications because the reduced packet sizes are transmitted across the network. More specifically, while each device on the network has a unique UID, the control of each device is not dependent upon the transmission of a recipient's UID in each message. Instead of specifying the UID(s) for each recipient of any given command, group identifications are communicated. In a network capable of identifying more than 65,000 devices (i.e., the two bytes of the UID can specify 65,000 possibilities), one can readily appreciate the data requirements associated with identifying one hundred let alone 1000+ devices using UIDs. Thus, the various embodiments use group flags to efficiently identify and instruct one or many devices to execute a specified command function (such as “open,”. “close,” “on,” “off” or the like).

Each device also preferably includes one or more status flags. These flags identify the current configuration of the device. For example, a status flag can indicate the height of a window covering relative to a bottom window sill position. Such indication can be, for example, in terms of motor drive counts, relative height in inches or meters or the like. Status flags are also utilized to inform other devices on the network of the configuration of the device, so that appropriate message transmission and/or other actions can be implemented.

In addition to storing device identification information, grouping information and status values, the memory/storage device also desirably includes in MOD devices (but generally not in BODs) at least one Adaptive access or Connectivity Table (“ACT”) when an HDNet compatible network is being implemented. As is discussed below, the ACT effectively enables the network to become “self-learning.” As shown in Table 1 below, the ACT provides a listing of each BOD device with which a MOD can communicate on the network. For the embodiment illustrated in Table 1, a MOD device can communicate with up to 16 (0 to 15) BOD devices on the network. Desirably, at any given time, 16 devices are listed in an ACT (assuming at least 16 devices exist on the network). When more than 16 devices are on a network, lower rated devices (as described hereinbelow) are removed from the ACT and replaced by higher rated devices so that a listing of the 16 devices with the highest connectivity rating is maintained. But, in other embodiments, it is to be appreciated that the ACT can be configured to list fewer or more devices. Also, in other embodiments, the ACT can be configured to store information regarding MODs, NCDs and/or other network components.

The ACT also provides an identification of the GID, NID, UID and group flags (as shown, 0 to 32) for each given device with which the MOD can communicate. Command status values (as set by the command status parameters) are also stored in the ACT. This information essentially provides a MOD with an indication of each device on the network, with which BODs the MOD can communicate, and the status of each listed BOD. Further, the ACT includes a “rating” field. The rating field is an indication of the quality of the communications channel that exists between the listed device and the MOD. Such ratings are commonly provided over a scale ranging from 1 to 10, with 10 signifying a very strong channel and 1 signifying a very weak channel.

Ratings are determined, for at least one embodiment of the present invention, by utilizing a counter algorithm. More particularly, each BOD device on a network periodically broadcasts a status message providing their address and status parameters. These “wake-up” messages are received by MODs (and/or other devices containing an ACT, if any) and are utilized to increment the rating parameter for the device in the corresponding row in the ACT. Meanwhile, the CPU periodically instructs the ACT to decrement the rating values for each device listed in the ACT. When the number of “wake-up” pulses received by a MOD from a given BOD device exceed the number of decrement pulses received from the CPU, the rating of the communications channel connecting the devices correspondingly increases. Similarly, when the number of decrement pulses exceed the number of “wake-up” messages, the rating of the communications channel with the device decreases in the ACT. In one particular embodiment, each BOD device is configured to communicate a “wake-up” message every 128 mSec and the CPU is configured to communicate a decrement pulse every 200 mSec. In other embodiments, such as those that are also/alternatively ZENSYS compatible, the “wake-up” message is communicated every 25 mS. Other timing parameters can also be utilized, as desired. In one embodiment, timing parameters are configured so that “wake-up” messages are received 1.5 times more often than decrement messages. Other ratios can also be utilized. Yet, it should be appreciated that more frequent message trafficking commonly results in decreased battery life (when battery power is being used by BODs to send the “wake-up” messages). Thus, a trade-off exists between system responsiveness and power considerations, especially power considerations in BODs.

The duration for which a device is in “sleeping” mode can also vary based upon the network protocol(s) implemented. For example, in an HDNet implementation, sleeping mode is desirably 170 mS, whereas in a ZIGBEE implementation “sleeping” lasts 15 mS. Again, it is to be appreciated that trade-offs should be considered when optimizing the battery life (primarily in BODs) in view of a desired duration for “sleeping” modes. Nonetheless, it should be appreciated that it is generally desirable (when a higher count represents a more reliable connection) for the “wake-up” messages to be generated more often than the decrement pulse in order for a reliable measurement of the quality of the communications channel between devices to be provided.

TABLE 1

| | Group | NET | Unit | | | | | Group | CMD |
|---|---|---|---|---|---|---|---|---|---|
| Device # | ID | ID | ID | Rating | Group 0 | Group 1 | . . . | 32 | Status |
| 0 | | | | | | | | | |
| 1 | | | | | | | | | |
| . | | | | | | | | | |
| . | | | | | | | | | |
| . | | | | | | | | | |
| 15 | | | | | | | | | |

In addition to maintaining an ACT for each MOD's connectivity with other BODs on the network, each MOD also maintains an ACT for all of the other MODs on the network. On a periodic basis, for example every 128 mSec, each MOD broadcasts to all of the other MODs on the network their ACT. Based upon information received in ACTs provided by other MODs, each MOD desirably updates their own ACT by comparing the ratings for each device listed on their ACT with ratings provided on other MOD's ACTs. When another MOD's ACT rating for a connection with a given BOD device is higher than the current MOD's rating, the MOD with the higher rating is desirably utilized to communicate with the BOD.

For example, as shown in FIG. 1, if both MOD “A” and MOD “B” are capable of communicating with BOD “D”, a determination is accomplished in both MOD A and MOD B as to which has the better/more reliable connection with BOD “D”. Suppose that MOD A has an ACT rating of 4 for BOD “D” and MOD “B” has an ACT rating of 6 for BOD “D” (as illustrated by the dashed versus the solid lines). In this instance, MOD “B” would assume responsibility for communicating messages to BOD “D”. In effect, this configuration provides that each BOD desirably will receive a message only once from any other MOD on the network. Such reduced message transmission protocol correspondingly reduces the processing requirements placed upon each BOD. Further, it is to be appreciated that as environmental and/or network conditions change, connectivity between any given set of MODs and BODs can change. The various embodiments of the present invention enable the network to correspondingly adapt to such changing conditions by suitably modifying ACTs and, as necessary, adding/deleting devices from ACTs.

Further, in the embodiment shown in FIG. 1, each MOD desirably broadcasts messages to every other MOD. However, in certain embodiments, the ranking of communications channels between MODs can also be accomplished. Further, as shown in FIG. 2, each MOD desirably includes a network traffic manager (“NTM”). Each NTM monitors the traffic on the data channel of the network and correspondingly adjusts the message traffic generated by its device. In one embodiment, such monitoring is accomplished by including a counter which decrements from a given value with each repetitive transmission of any given command. For example, during periods of low network activity, a MOD can be configured by the NTM to repeat the transmission of a command a given number, such as five times, over a given time period, e.g., a minute. In high network volume environments, repetition can occur at a reduced rate, e.g., twice, if at all, and/or over a longer time period, e.g., five minutes. Thus, NTMs desirably are included in MODs and assist the CPU in adjusting the number of repeats and the repeat interval for messages and commands, on a real-time basis, in order to control network traffic flow. The NTMs, for at least one embodiment, are configured to monitor and optimize traffic flow on the data channel. Commonly, the NTM does not monitor the “wake-up” channel, in which instance the BODs can send their signals without limitations, which desirably results in further power savings.

NTMs also can be utilized to determine redundancies between MOD devices, BODs, and/or NCDs. In the event that a communication channel between a MOD and a BOD, or a MOD and an NCD, fails or is otherwise substantially degraded, the network can timely adapt to such failure by establishing new communication channels across the network. The network can adapt to ensure the effected devices can directly or indirectly communicate with each other, as needed.

In other embodiments of the present invention, routing tables can also be utilized. A routing table desirably identifies which repeaters can be utilized to reach a given device on the network. Notably, the routing table can be provided and utilized in conjunction with the ACT or in lieu of the ACT. Desirably, each MOD contains a routing table, when such a configuration is implemented in a given embodiment. Further, when new MODs are added to such a system configuration, desirably the routing table is updated (similar to the ACT update process) to identify which devices can be used to repeat or route communication messages to other devices.

Further, MODS can be configured to also include controller identifiers. In a table or other data structure, the MODS can be configured to store and recognize which controllers can be used to control the device. Also, MODS can be configured to: exclude certain controllers access to the network; respond only to certain controllers; not respond or repeat messages from other controllers; and the like.

Referring again to FIG. 2, each MOD also desirably includes at least one device driver. As mentioned above, the various embodiments of the present invention can be utilized in any number of applications including, but not limited to, powered window coverings, security systems, awnings and the like. Accordingly, any number of device drivers can be provided for receiving instructions from the CPU and controlling the operation of motors, actuators, sensors and the like. Desirably, up to 256 commands can be communicated across a network. Such commands can correspond to one or many device drivers.

BODs

As discussed above with reference to MODs, BODs also can contain many of the same or similar components. A BOD commonly includes a CPU, a memory/storage device, a network communications interface, a power module (which as discussed above is commonly connected to and/or includes a battery or other non-line power source) and at least one device driver. With regards to the CPU, in one particular embodiment a MicroChip 16LV870 processor is utilized with 2 Kbytes of on-board memory. Other processors, controllers and the like, however, can be suitably utilized. The data, instructions, operations, features and/or functions of BODs, in general, and processors, in particular, can be suitably configured using hard-coding, propagated signals and/or computer readable mediums. Similarly, the memory/storage device desirably includes data structures and instructions for storing a GID, NID, UID, group flags and status flags. However, BODs desirably are not configured to store ACTs, are not utilized to relay messages to other devices on the network, and do not maintain or store network status information. Instead, BODs, which are commonly constrained by power limitations inherent in battery and low voltage systems, desirably are configured to broadcast their “wake-up” message on a periodic basis (currently, every 128 mSec), receive messages from MODs and/or NCDs and implement such messages via their device drivers. With the exception of generating status messages and with respect to command messages, BODs, in at least one embodiment of the present invention, are generally passive, receive only devices.

NCDs

As mentioned previously above, NCDs are also commonly utilized in conjunction with the network architecture of the present invention. In one embodiment, NCDs comprise remote control devices which include one or more buttons or other user interface components (such as voice activation, stylus, multimodal interfaces, touch sensitive, keyboards, and the like), a CPU, a memory/storage device, and a network communications interface (NCI). In one embodiment, the CPU is a MicroChip 16LV870 with 2 Kbytes of memory. Similarly, the NCI is desirably a 2.4 GHz compatible transceiver such as the Nordic NRF 2401. It is to be appreciated that other suitable devices can be utilized as the CPU and/or transceiver.

The NCD also commonly contains a memory/storage device. The memory can be provided on-board or off-board with the CPU. Desirably, such memory includes one or more data structures for storing the NCD's GID, NID, UID and group flags. This data, the GID, NID and/or UID, is desirably programmed and stored in the memory device in the NCD. A command listing is also desirably provided in the memory for selecting commands to be provided to one or more (or groupings thereof) MODs and/or BODs. Since the NCD is commonly utilized as a control device, device drivers are not commonly included. However, it is to be appreciated that NCDs can include device drivers should a particular implementation so require.

Further, NCDs are not limited to remote control devices, such as those commonly utilized to control or select features and functions on a wide variety of devices. Instead and/or in addition to, NCDs (there can be more than one in any given network) can include personal computers, mainframe computers, minicomputers, Personal Data Assistants, hand-held computers, tablet PCs, wireless communication devices such as cell-phones and “smart” phones and other control capable devices. Such devices can use any of a variety of operating systems and application development environments including, but not limited to, J2ME, BREW, XML, XHTML, WML, PocketPC, Symbian, Palm, Linux, Unix, Windows, Apple, Internet Explorer, Netscape, AJAX, and other web browser based implementations, Java, Java 2, variants of the foregoing and others. Further, the NCD can be controlled and/or used directly and/or indirectly (e.g., via the Internet or another network). The NCD can also provide and/or facilitate multi-modal control features, such as controlling networked and non-networked devices (example, a home entertainment system not on the network). In short, any device capable of generating a wireless, wired or combination thereof control signal to be received and implemented by one or more MODs or BODs, consistent with the teachings of the various embodiments of the present invention, can be utilized.

In one particular embodiment of an NCD, a basic remote control device is provided. This basic device desirably is configured to operate three distinct devices (e.g., three shades), three distinct groups of devices or combinations thereof (e.g., one shade and two groups). Thus, only three group flags are utilized instead of the 32 otherwise desirably available. Additionally, this basic remote includes a command listing of three options: raise shade, lower shade and tilt vanes. In other embodiments, up to 256 commands can be provided including, but not limited to, slow run modes, vane position controls, multiple motor synchronizations, activating lights, deactivating lights, locking gates, unlocking gates, weather guard controls and others. Further, with the expansion of additional control bits and/or other encoding approaches, more commands can be provided in any given implementation.

In use, the basic NCD provides for the user selection of a “group” to whom a command is to be propagated, and then the user selection of the command, at which instance the command is then propagated, using the data protocol of the present invention, to the device(s) identified by the selected group. For example, a network can be configured so that a single device responds to group “1” signals (such configuration occurring by properly programming devices on the network so that only the desired device has the group “1” flag set). When the user selects the group “1” button, the NCD suitably sets the group “1” flag in the data protocol (as discussed in greater detail below) compliant message and communicates the selected command to the network (which suitably relays the command, as necessary, to the device previously identified with group 1).

In another embodiment of an NCD, a more advanced remote control device is provided. This advanced device desirably enables a user to have full access to all of the available control features in a particular implementation. Such device can include interactive user interfaces which can generate audible, tactile and/or visual signals for generation thereby or in conjunction with another device (e.g., the NCD in conjunction with a flat panel monitor provides the desired interface with the user). As discussed previously, multiple UIDs and multiple combinations of GID and NIDs can exist. Similarly, each GID, NID and/or UID combination can be associated with multiple group flag settings, operating upon any number of commands. Thus, practically limitless opportunities exist for controlling individual devices, networks, groupings and/or combinations thereof. To facilitate such advanced controls, desirably a liquid crystal display or similar display (whether on the device or otherwise provided by another component, such as television or computer monitor) is provided.

In yet another embodiment of an NCD, a deluxe remote control device is provided. Preferably, the deluxe remote includes greater and/or additional graphical display capabilities. Such display capabilities can include the ability to generate network maps, identify group devices, repeater devices, individual devices and the like. The graphical display capabilities also provide network status information, advanced user interface menus and the like. Touch screens, buttons, audible and/or other user interface technologies can be used in the deluxe remote. Further, the deluxe remote is desirably configured to be able to store network information beyond those devices with which it can have established communications links.

The deluxe remote can also be configured in embodiments of the present invention to include a routing table, a routing map, ACTs and other data structures which indicate the status, connectivity and elements of the network. However, such routing information is not required to utilize a deluxe remote. A mere listing of UIDs for MODS, BODS and NCDs in a network may be used in other embodiments.

Similarly, such UID and/or routing information can be used, for example, to create, delete, add, or modify groupings of devices, and communications links and paths between devices. Further, individual devices on a network can also suitably be identified to and controllable by the deluxe remote. UIDs can be desirably stored on the remote and can be assigned specific names (e.g., dining room chandelier; back door sensor, or the like).

Likewise, the deluxe remote may be configured to include group identifiers and flags and to use such identifiers and/or flags to communicate messages to other devices on the network. In another embodiment, when group commands are to be transmitted, the deluxe remote can be configured to communicate each UID n a series or to use the before mentioned masking techniques. Thus, it is to be appreciated that the remote control and network control devices of the various embodiments of the present invention may have wide ranging capabilities and applications.

Further, the control of network devices using a deluxe remote can be accomplished manually or automatically. For example, irrigation systems and/or zones can be controlled based upon timers, rain sensors, and manually. Customized and adaptive programs can also be implemented in the deluxe remote based upon inputs received (e.g., a rain gauge for 24 hours) and instructions/algorithms provided to the remote.

Similarly, it is to be appreciated that the control components previously described above with regards to MODs and BODs can be provided independent of the actual device (e.g., shade) to be controlled. For example, a motor to raise a shade is commonly positioned in a header assembly for the shade. However, the control electronics (as encompassed in a MOD or BOD) can be separately located and connected wirelessly or by wire to the motor.

In addition to NCDs, remotes, advanced remotes and/or deluxe remotes, personal computer and other computer systems (e.g., personal data assistants, smart phones, gaming consoles and others) may be used to control and/or monitor the status of a network. In one particular embodiment, a Universal Serial Bus (“USB”) “dongle” desirably contains the necessary network transceiver components that enable the dongle to interface with the network while also communicating (via the USB interface) with a computer system (to which the dongle is attached) Computer software on the computer is desirably loaded, separately or from the dongle itself, onto the computer. Such software converts the computer effectively into a basic, advanced and/or deluxe remote. The “dongle” adapted computer (i.e., the “Sniffer”) desirably then functions and operates as an embodiment of a remote or other NCD, as described above.

Similarly, a Sniffer may be configured to facilitate network installation, configuration, support and troubleshooting. By attaching a Sniffer to a web enabled computer, for example, remote network configuration, monitoring and/or support may be accomplished. Similarly, during installation of the network, the Sniffer may be used to facilitate network troubleshooting and support functions with remote help desks and the like; thereby eliminating and/or reducing the need and expense of on-site network installers.

Data Protocol

As discussed previously hereinabove, the MODs, BODs and NCDs commonly utilize five sets of data parameters to facilitate communications. These are: GIDs, NIDs, UIDs, group flags and commands. As mentioned previously, in at least one embodiment, the GID identifies a manufacturer of a device and a specific implementation thereof. The NID identifies the network with which the device is associated. The UID identifies the device sending the communications/the propagated signal. The group flags (of which 32 desirably exist) identify to which groupings of devices the command/propagated signal is directed, and the commands provide the data/instructions/commands or the like. It is to be appreciated that in certain embodiments, some of these data parameters can not be utilized or supported. For example, in a rather limited implementation, using a basic NCD, three groupings can exist and one type of product can be supported. In such an embodiment, and the remaining 29 group flags can be unnecessary and thus could be eliminated from any data protocols and/or propagated signals (as permitted by the specific implementation thereof). In other embodiments, a greater number of group flags, and/or other information, such as check bits, security codes, and the like can be provided in or encoded into those data parameters communicated between devices. Thus, the data protocols used are appreciably contractible and expandable.

In one particular embodiment, the data protocol is desirably as shown below:
GID (2 bytes), NID (2 bytes), UID (2 bytes), Command/Control (1 byte), Group Flags (4 bytes)

As shown, this preferred data protocol provides a compact, 11 byte (88 bit), message delivery system that desirably minimizes power otherwise utilized to process and interpret commands. In other embodiments, such as those compatible with ZENSYS, more bytes can be used. Such an implementation can utilize, for example, 12 to 30 bytes of data. Thus, it is to be appreciated that the data protocol can expand or contract based upon specific implementations and architecture(s) supported.

Network Security

Preventing unauthorized users to access and control devices on a network is a primary consideration of any network designer and user. In the various embodiments of the present invention, commonly known and understood security mechanisms, such as authentication, scrambling/descrambling, checksums of data packets, encryption of signals, frequency hopping, public and private keys, and others can be utilized, as desired. Additionally and/or alternatively and depending upon security requirements for any given installation, network security can also be provided by limiting access to programming, the learning of device codes and restricting the time period when device codes and network identifiers can be programmed into certain devices. In at least one embodiment of the present invention, desirably MODs can only enter program mode within a given time period, such as 10 seconds, from receiving power from a main power source. Programming time constraints can also be used in BODs and NCDs. In other embodiments, the programming of a device can be constrained by time based upon the entrance of a factory supplied PIN or other programming code. For example, only after entering the PIN, and only within a given time frame thereof, can the device (MOD, BOD, NCD) be programmed.

Other commonly appreciated programming security features can also be used in conjunction with the present invention. Lock codes, which disable buttons on remotes until a pre-determined sequence is entered, PIN numbers which can be entered into advance remotes to enable use of the NCD can also be utilized. Similarly, the location of the CPU and associated electronics can also be positioned inside buildings, in hidden locations and otherwise to discourage unauthorized access to the same. In one particular embodiment of the present invention, MODs and BODs are desirably configured to only accept low power signals, generated in close proximity to the receiving device. In effect, such an approach prohibits unauthorized users from inputting command/programming sequences due to the low power signal and the inability of such signals to propagate long distances. Also, various embodiments of the present invention can support group programming, wherein a plurality of like devices are programmed at one time, thereby minimizing the possibility of interception of such signals, as well as reducing the time and power requirements necessary to accomplish such programming.

Since a given installation of MODs and BODs will commonly utilize a single GID and NID, in certain installations, pre-programming of MODs, BODs, and NCDs can be accomplished at the factory and/or by trained installers. Such an implementation provides additional security because devices can be suitably configured to accept programming only upon connection to the same (either physically or virtually) computers or other devices implementing specialized programming routines.

For certain applications and application environments, security is important. For such applications, critical security features such as data encryption, frame integrity, and sequential freshness can be provided. Frame security is a service that enables a receiving device to detect the modification of a message by parties without the correct cryptographic key, by appending a message integrity code to the message. To avoid replay attacks to a network, in which an old message is stored by an entity without the cryptographic key and then replayed later, an ordered sequence of values can be appended to the message. When received, this freshness value is compared against a stored value; if it is fresher than the stored value the freshness check passes and the new freshness value is stored. An unsecured mode, where no security is provided, can also be provided. This mode is useful for applications in which implementation cost is important, and security is less important or not required.

It is also to be appreciated that the 11 byte protocol, as discussed above, also provides certain security features and capabilities. Scrambling, pseudo-random order sequencing of data values and other techniques can be utilized to mask or otherwise scramble GIDs, NIDs, UIDs, commands and/or group flags. Thus, it is to be appreciated that practically any security methodology can be utilized to secure transmission between devices during programming and/or operation of the same.

Versioning

To accommodate future functionality, versioning features can be provided that allow backward compatibility with network components having an older version of software. Thus in a given installation within a facility which could be home or industrial environment, there could be one or more components or network elements that belong to different generation of a network's evolution and still be able to communicate and function.

Interface Between the Network Protocol and ZIGBEE Protocol

It is possible that in future, a home or industrial environment might have some network components that are not compliant with the present embodiments of a network. For example, some of the network elements (BOD or MOD) might follow the ZIGBEE protocol. To enhance user experience and remove confusion, the present invention works on open APIs that can work with ZIGBEE (all variants) so that an NCD can control ZIGBEE network elements and components which can also be configured and designed to work with the network elements (BODs or MODs) of the present invention.

Interface Between Network Protocols and ZENSYS' Z-Wave Protocol

It is possible that in future, a home or industrial environment might have some network components that are not compliant with the present invention. For example, some of the network elements (BOD or MOD) might follow Z-wave protocol. To enhance user experience and remove confusion, the various embodiments of the present invention can be configured to be compatible with open APIs that work with Z-wave (all variants) so that an NCD can control Z-wave network elements and Z-wave NCD (and other network components) can be configured and designed to work with other network elements (BODs or MODs).

Interface Between Network Protocol and Other Proprietary or Standards-Based Sensor Protocols

It is possible that in future, a home or industrial environment might have some network components that are not compliant herewith, for example, some of the network elements (BOD or MOD) might follow other proprietary or standards-based sensor technologies. To enhance user experience and remove confusion, the network is desirably compatible with open APIs that can work with other sensor technologies. Specifically, an NCD can control network elements using other sensor technologies. Likewise, NCD (and other network components) of other sensor technologies can be configured and designed to work with the network elements (BODs or MODs) of the present invention.

MOD Operation

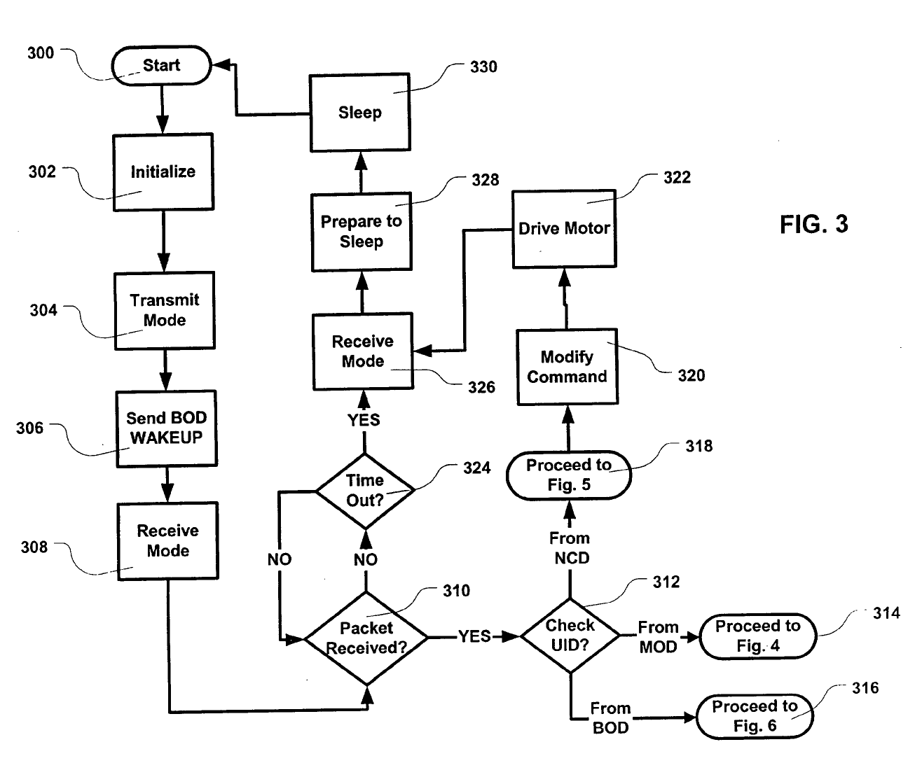

Referring now to FIG. 3, one embodiment of the process flow for operating a MOD, in an implementation of the present invention, is shown. Desirably, this operational process flow begins with initialization of the MOD (Operation 302). As discussed previously above with respect to at least one embodiment, MODs desirably are initialized within a give time period upon receiving main power. Initialization commonly includes receiving a GID (if one was not pre-programmed), receiving one or more NIDs (if not pre-programmed) and configuring those group flags to which the MOD desirably will respond. As mentioned previously, the NID is commonly provided as a randomly generated code by an NCD, thus, during initialization, the device is commonly associated with a NID. Also, during initialization, the UID can be provided. Desirably, the UID is commonly factory set and thus need not be initialized. However, when not factory set, UID initialization can also occur. Once the MOD is initialized with its own data parameters and settings, desirably the MOD begins to construct its ACT. As discussed above, each MOD on the network desirably broadcasts its ACT to every other MOD on the network every 128 mSec. Similarly, each BOD transmits a “wake-up” message every 128 mSec. Thus, when initializing, the MOD begins to increment and decrement ratings for BODs in its own ACT, while storing other MODs ACTs (which it is to be appreciated can change as the new MOD comes on-line). After a predetermined period of time, the MOD then compares its ACT with those received (and stored) from other MODs on the network in order to begin identifying those BODs with whom the device will be responsible for then communicating. After a period of time, such period is generally dependent upon the size of the network (i.e., a larger network will take longer to initialize a MOD then a smaller network), the MOD's ACT is generally initialized, and the MOD is ready to operate on the network.

After initialization mode, the MOD is then configured in transmit mode or operation mode (Operation 304). At this instance, the MOD desirably transmits to each BOD on its ACT a “BOD wake-up” message (Operation 306). This message is basically a challenge and reply which results in any BOD (as identified by a corresponding group flag) broadcasting a reply to such challenge. In essence, during this phase of operation, the MOD verifies the links identified in its ACT operate as desired.

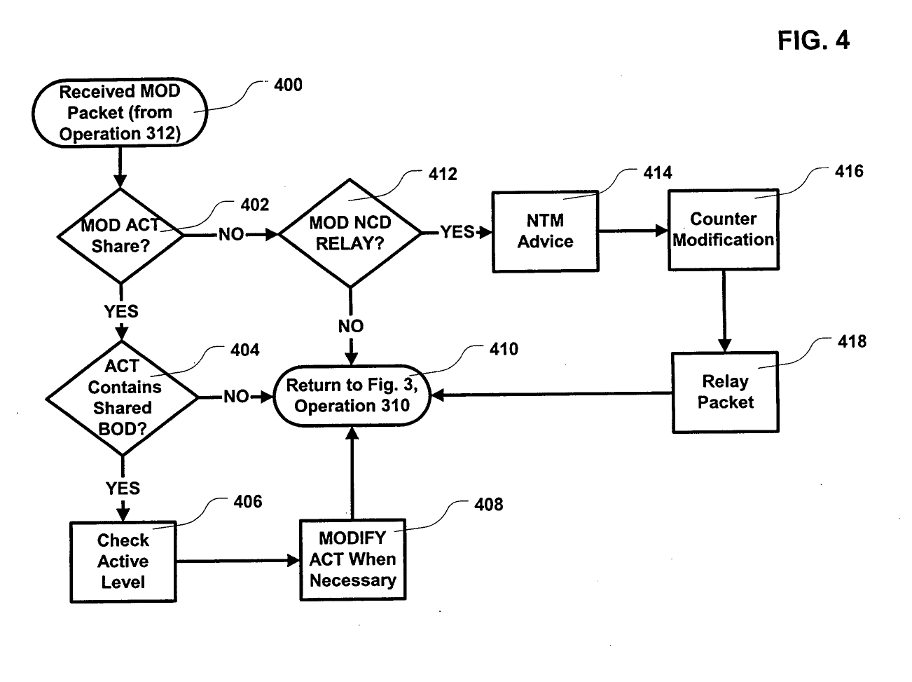

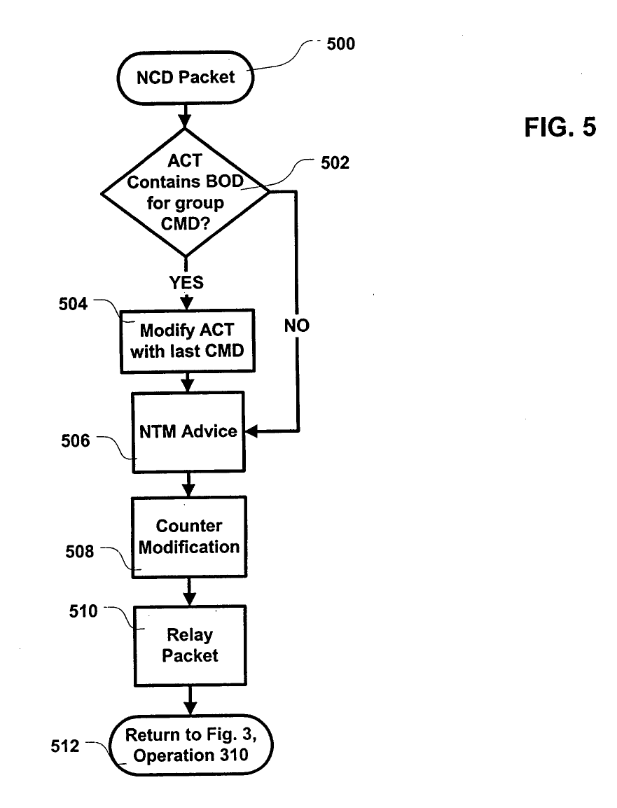

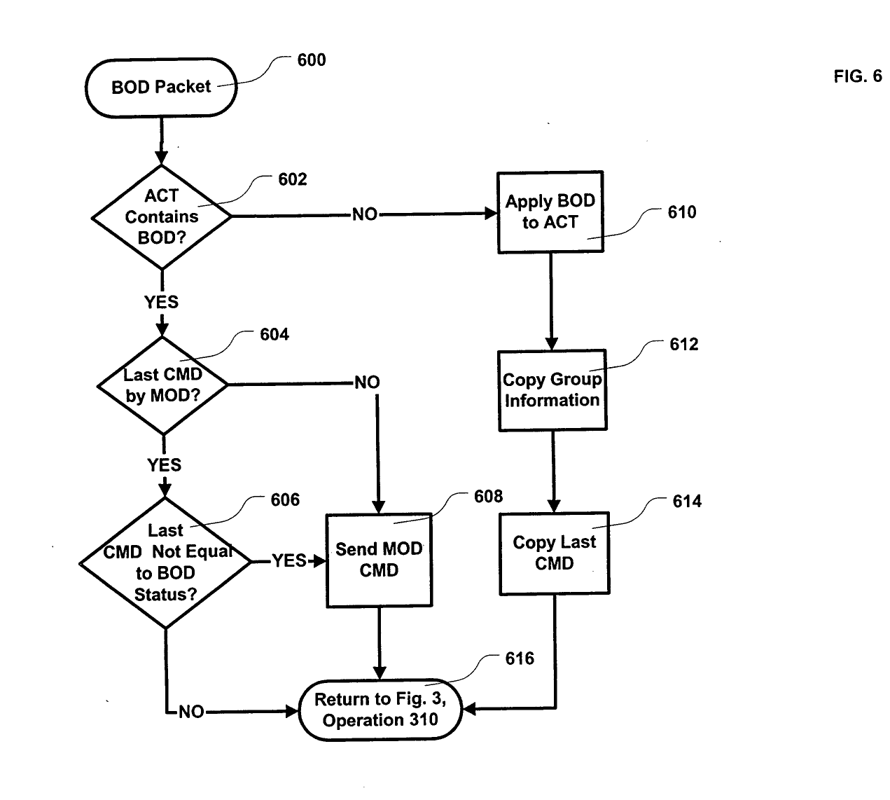

Next, the MOD enters “receive mode” (Operation 308). Receive mode desirably exists for a given time period. During this mode the MOD “listens” for commands (e.g., those from an NCD or another MOD) (Operation 310). When a command packet is received (Operation 312), the MOD first compares the UID with those listed in its ACT and those identified as belonging to other networked devices (MODs, BODs and NCDs). If the UID identifies the message as being from another MOD (Operation 314), the operations proceed with MOD message processing, as discussed below with reference to FIG. 4. If the UID identifies the message as being from an NCD (Operation 318), the operations proceed with NCD message processing, as discussed below with reference to FIG. 5. Last, if the UID identifies the message as being from another BOD (Operation 316), the operations proceeds with BOD message processing, as discussed below with reference to FIG. 6.

As shown in FIG. 3 when the UID is identified as having been generated by an NCD, in addition to performing the operations illustrated in FIG. 5 and described below, the MOD implements the command (Operation 320) and drives any motors or other actuators (Operation 322), provided the MOD is associated with the group identified in the data packet (for example, group “1”). If the MOD is not associated with the group identified in the data packet, then the command is not implemented by the MOD and processing resumes with operation 326 (awaiting the receipt of the next data packet).

As further shown in FIG. 3, the device desirably can be configured to reside in “receive” mode (Operation 308-310-324-326) for a given period of time. After a lapsing of such time period, assuming no commands were received during such time period, the device desirably enters into “sleep” mode (Operation 328). Sleep mode effectively minimizes power consumption in BODs (and in MODs, but, in MODs power consumption is of less concern) by reducing the number of challenges and replies required. It is to be appreciated, however, that in one preferred embodiment “wake-up” messages are generated by BODs every 128 mSec regardless of MOD operation status.

Referring now to FIG. 4, one embodiment by which a MOD (e.g., MOD “A”) can handle a data packet (a.k.a. a message) received over the network from another MOD (e.g., MOD “B”), in an implementation of the present invention, is illustrated (Operation 400). Desirably, each data packet received by MOD “A” from a second MOD “B” is examined in order to determine whether the data packet contains another MODs ACT table, i.e., is the data packet sharing an ACT with another MOD (Operation 402). It is to be appreciated, that MODs on the network often relay data packets received from other MODs and BODs on the network. As such, the transmitter of a data packet can not be the originator of the data contained in such packet. Thus, in the case of receiving an ACT, it is to be appreciated, that such ACT can be from any of the MODs on the network.

Once the data packet is received and verified to contain an ACT for a MOD, processing desirably continues with MOD “A” examining the received ACT and comparing the information contained therein with MOD “A's” ACT for common entries or “shared BODs” (Operation 404). If no shared BODs exist, then the received ACT is suitably stored in MOD A's memory/storage device and MOD A resumes waiting for the next received message or the next scheduled event, whichever occurs first (Operation 410).

If the received ACT does contain one or more identical “shared BODs” with MOD A, then MOD A proceeds with checking the rating (or active level) of each shared BOD in MOD A's ACT and comparing such rating to the rating indicated in the received ACT (Operation 406). If the rating in MOD A is higher than the rating in the received ACT, then no further processing is necessary. In contrast, if the rating in MOD A is lower than the rating in the received ACT, for any given BOD, then MOD A's ACT is accordingly modified to identify that the MOD with the higher rating should be used to communicate messages to the designated BODs (Operation 408). As mentioned previously, desirably those MODs with the strongest connections to any given BOD are primarily utilized to communicate messages to such BOD.

Still referring to FIG. 4, as mentioned above, MOD A commonly first examines each received data packet for whether it contains an ACT (Operation 402). If not, then processing desirably proceeds with examining the message for whether it is one from an NCD that is to be relayed to other MODs and/or BODs on the network (Operation 412). As one can appreciate, MOD A can receive broadcast messages from other MODs that are designated for receipt by a given device on the network, other than MOD A, and thus do not require any further communication, processing or action. Thus, since each MOD desirably receives every transmission for MODs within MOD A's receiving range, MOD A suitably determines whether the received message is one which needs to be further relayed to other devices on the network. If not, then processing of the received message by MOD A, but not necessarily by other MODs on the network, resumes with the processing set forth in FIG. 3 and as discussed above (Operation 410).

If the received message is one which needs to be relayed to other devices on the network, then processing desirably continues, for at least one embodiment of the present invention, with seeking advice from MOD A's network traffic manager (NTM) (Operation 414). It is to be appreciated that seeking advice from an NTM can be considered to be an optional function of the various embodiments of the present invention, and thus can not be utilized or performed in all instances.

Desirably, the NTM receives the request for advice from MOD A, and determines an appropriate and/or desirable time to further transmit/relay the received message. A counter is suitably incremented (Operation 416), so that messages are not unnecessarily repeatedly sent to device(s) which, for whatever reason, can not receive such messages or identify receipt of the same. The message/data packet is then relayed on the network (Operation 418) and processing resumes (Operation 410). For one embodiment, a broadcast transmission topology is utilized. As such, when designated, the CPU for MOD A instructs the NCI to broadcast/retransmit the received message. Also, in certain embodiments, wherein the ratings for MODs on the network are also stored in an ACT or similar data structure, the rating for the MOD from whom the data packet was received is also desirably increased, thereby further indicating that the strength of the communications link between MOD A and the MOD from whom the message was received.

It is to be appreciated that FIG. 4 provides one illustration of one embodiment by which a MOD can receive, examine, process and, when necessary, retransmit data packets on the network. It is to be appreciated that the process flows described herein can be suitably modified, as desired, to provide any desired level of functionality and/or support any desired type of network communications topology.

Referring now to FIG. 5, one embodiment of a process flow by which a MOD can process a data packet received from an NCD is illustrated (Operation 500). As shown, this embodiment desirably begins with an examination of the received data packet for whether it contains a message for a BOD listed on the receiving MOD's (MOD “A”) ACT (Operation 502). If so, then the status of the BOD, as listed on MOD A's ACT, is desirably updated (Operation 504). If the BOD is not listed on MOD A's ACT, then processing desirably continues with seeking advice from the NTM (Operation 506).

As provided above, advice from the NTM desirably provides for identifying an optimum time to retransmit the message received from the NCD on the network. For one embodiment of the present invention, each MOD retransmits each message received (whether from another MOD or another NCD) a given number of times, as determined by the NCD (Operations 508-510). With the transmission of messages to other MODs/BODs (Operation 504), ratings associated with each are also correspondingly modified. In at least one embodiment, the ratings are modified upon the receipt of a status message from the BOD(s) to whom the NCD message was originally designated. Such status message desirably indicates that the actual status of the device is identical to the predicted status of the device (after implementation of the message). For example, upon the receipt of a command from an NCD to raise a shade, MOD A's suitably updates it's ACT to reflect the “up” status and retransmits the message. Upon receipt of the message, those identified BODs (as identified by GID, NID, and group flags values) execute the message and on the next 128 mSec update identify the status of the device as being “up.” Upon receipt of the “up” message(s) from the BOD(s), MOD A then updates its rating for the BOD(s) and thereby indicates that strength of the communication link between MOD A and the BOD(s).

It is to be appreciated, however, that in other network embodiments, instead and/or in addition to broadcast transmissions, point-to-point, simulcast, multicast or other schemes can be utilized. In one alternative embodiment, MOD A determines whether and to whom to retransmit a received message from an NCD or another MOD, by examining the other MOD's ACTs (as stored in MOD A's memory). For example, if an NCD has issued a data packet providing a command for BODs 1, 3 and 5, and MOD A only lists BOD 1 on its ACT, but MOD B lists BODS 3 and 5 on it's respective ACT, the MOD A suitably retransmits the received data packet to BOD 1 and, as directed by the NTM, to MOD B. MOD B, in turn, then retransmits the received data packet to BODs 3 and 5.

Yet in another embodiment, MODs can be “intelligent” with regards to the location of NCDs. For example, when an NCD is located at a fixed location, each MODs ACT can be configured to identify whether it does (e.g., by the presence of the NCD on the ACT or other network configuration data structure/listing) or does not (e.g., by the absence of the NCD on the ACT or other network configuration data structure/listing) receive messages from an NCD. Similarly, when the NCD is transportable (e.g., one similar in size to a television remote), desirably the NCD periodically sends out status messages, which MODs then use to rate the connection with the NCD, just as ratings with MODs and other BODs are accomplished. Thus, it is to be appreciated that the adaptive network can “adapt” to ever changing network configuration and/or communication capabilities and “self-learn” the optimum network data transmission configuration (i.e., to whom and when messages are transmitted/relayed). Further, the use of ACTs desirably results in an efficient communications scheme which minimizes network traffic, permits the use of compact data structures and minimizes power use.

Referring now to FIG. 6, one embodiment of an implementation of the present invention by which a MOD processes a data packet/message received from a BOD is illustrated (Operation 600). Specifically, upon receipt of message from a BOD (as identified by the UID set forth in the packet), MOD A determines whether it's ACT lists the BOD (Operation 602). If not, then the BOD is added to the ACT for MOD A (Operation 610). Also, MOD A desirably deciphers or copies from the data packet the group flags, as well as the last command, identified by the BOD into the ACT (Operations 612-614). Thus, upon receiving a message from a BOD which is not listed in the MOD's ACT, the MOD obtains a listing of the groups to which the BOD belongs as well as its current status (assuming the last command received by the BOD is reflective of the BODs current status or configuration).

It is to be appreciated, that the listing and delisting of BODs on ACTs is a repetitive event. As such, when a MOD, which previously had been identified as having a “best” connection with a given BOD is suddenly not available on the network, other MODs within range of the BOD can assume the message communication duties previously accomplished by the unavailable MOD.

Referring again to FIG. 6, when MOD A's ACT contains a listing of the BOD from which the data packet is received, processing desirably continues with determining whether the last command sent to the BOD was from MOD A by comparing the ranking for the BOD on MOD A's ACT with the rankings on other MOD's ACTs (Operation 604). If not, then MOD A sends to the BOD the last known command, assuming MOD A's ACT ranking is now greater for the BOD than other MOD's ACT ranking for the BOD (Operation 608). In certain embodiments, MOD A will send the last command only if a time-out condition has not been reached. Such time-out condition can be set and/or determined by the NTM. Alternatively, if the last command was sent to the BOD by MOD A, then processing desirably continues with comparing the current status of the BOD with the status requested by the last command (Operation 606). For example, if the last command by MOD A was shade “up.” Then the data packet subsequently received from the BOD should represent the status of the shade being “up.”

If the current status of the BOD does not reflect the anticipated status, as indicated by the last command sent by MOD A, then the last command is retransmitted to the BOD (Operation 608). Again, such retransmission desirably only occurs from that MOD which has the highest rating with the given BOD. In this regards, repetitive and/or conflicting messages are desirably not transmitted by other MODs on the network to any given BOD. Further, retransmissions desirably occur under the guidance and control of the NTM. Thus, if a given number of repetitive message transmissions to a give BOD are not successfully acknowledged, communications responsibilities will eventually transfer to another MOD, if any, with a greater/more reliable communications connection. Again, the network desirably adapts to the environment in which it operates. Operations for the MOD, suitably resume with those illustrated in FIG. 3 and discussed hereinabove (Operation 616).

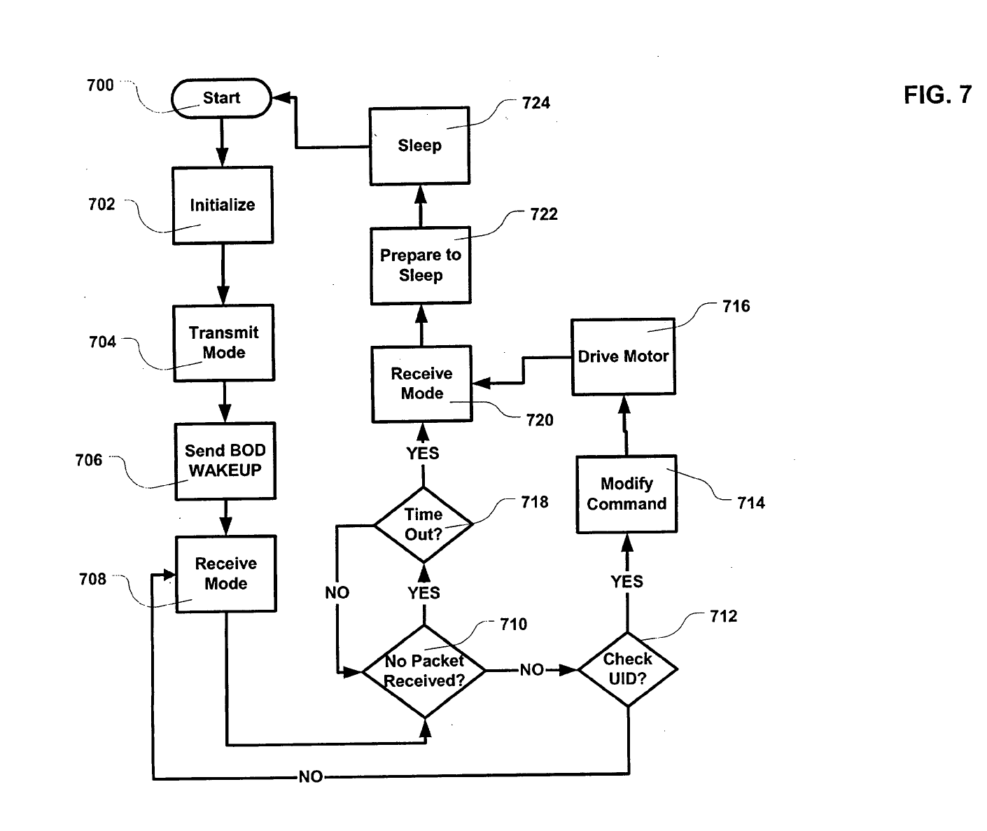

Referring now to FIG. 7, for at least one embodiment of the present invention, a process flow utilized by a BOD is illustrated (Operation 700). As was provided with MOD processing, BOD processing generally begins with initialization (Operation 702). Desirably, for purposes of security and otherwise, initialization begins and should occur within a given time period from power-up. Also, initialization commonly requires low level power signals, such as those generated by an NCD in close proximity to the BOD, be utilized. However, in certain embodiments, BODs are commonly not utilized in security intensive or specific implementations and thus can not be subjected to stringent security induced programming and initialization constraints.

Once the BOD is initialized with its GID and UID (which desirably are factory or installer set) and NID and group flags (which, as discussed above, are set based upon signals received from an NCD), operation of the device on the network begins and the device enters “transmit mode” (Operation 704). As discussed previously, during normal operations, a BOD transmits a “wake-up” message every 128 mSec. Once such message is transmitted, the BOD then enters “receive” mode, during which the BOD awaits messages from other MODs or NCDs on the network (Operation 708). As such it is to be appreciated that the majority of a BODs time is spent awaiting receipt of messages and only approximately 13% of the battery time is spent transmitting messages. Other ratios of transmit to receive time can be utilized in other embodiments of the present invention with corresponding tradeoffs in battery life and the frequency of network status updates.

As shown in FIG. 7, while in receive mode, the BOD awaits reception of a data packet (Operation 710). If a packet is received, the BOD determines if the UID, GID, NID and group flags correspond to those specified for the BOD (Operation 712). If so, then the BOD executes the command, updates it's status variables (i.e., the “command” variable(s)) and instructs the device drivers to take the appropriate action (e.g., driving the motor, tilting vanes, activating lights or the like) (Operations 714-716). At this point, the device then desirably enters “sleep” mode for a predetermined time period (Operations 720-724), at which instance the process loop repeats itself with entering transmit mode and transmitting the previously mentioned “wake-up” message(s). However, if no packet is received (Operation 710) within a given time period, the BOD progresses out of receive mode and enters “sleep” mode (Operations 718-724). In at least one embodiment, during sleep mode, the BOD desirably stops “listening” for new messages in order to minimize operations to essential functions only, thereby further preserving battery life. In other embodiments, “sleep” mode can entail passive “listening” for new messages that exceed a given signal strength and thus are indicative of a message coming from a designated and/or associated NCD or MOD. Further, one should appreciate that by appropriately setting the repeat intervals in a NTM and the duration of sleep mode in a BOD, one can configure the system such that during most time periods the BOD is not actively processing messages, but, at the same time, does not miss those messages timely communicated to the BOD.

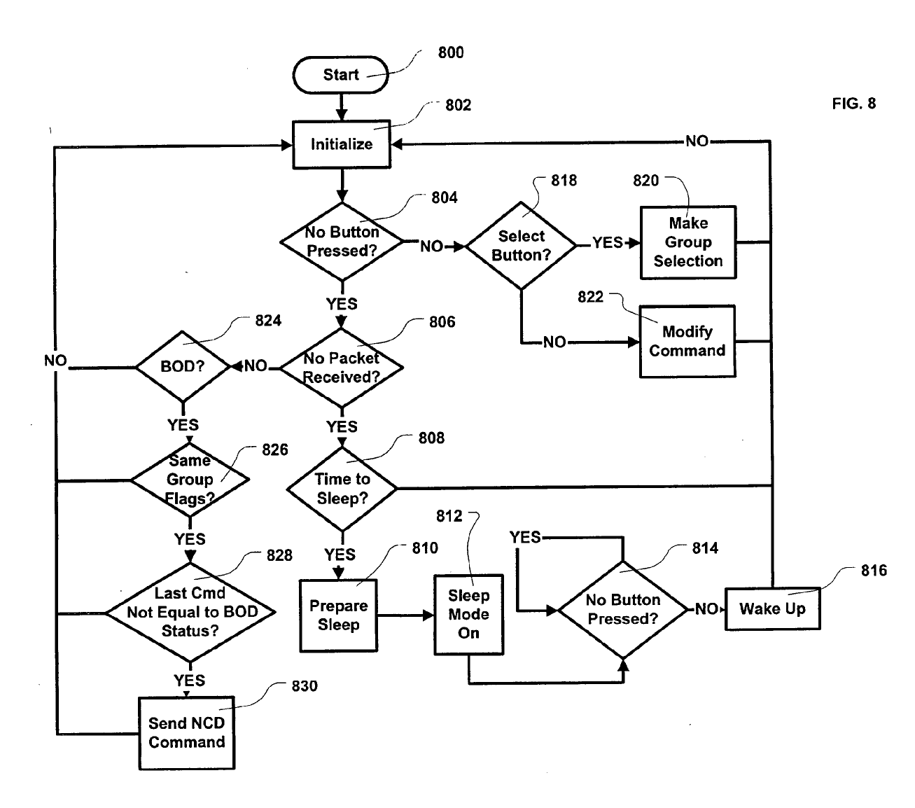

Referring now to FIG. 8, for at least one embodiment of the present invention, a process flow utilized by an NCD is illustrated (Operation 800). This process flow begins with initialization of the NCD (Operation 802). An NCD is commonly configured to recognize a single GID and one NID. Further, each NCD is desirably programmed, during system initialization, to recognize multiple group flags. For example, shades in a kitchen and dining area might be on the same network as those in a living room, but, are recognized by different group flag settings (e.g., the kitchen shades might be recognized by group flag 1, the dining area by group flag 2 and the living room by group flag 3).

Once initialized, operation of the NCD essentially enters a “sleep” mode, in which messages are not received or transmitted. However, in certain embodiments, NCDs can be configured to receive messages from BODs and/or MODs and maintain network status configurations, ACTs and the like. Such configuration information can be useful for diagnostic, programming, security and other uses.

While in “sleep” mode, for at least one embodiment, the NCD awaits the depressing of one or more buttons, voice commands or input signals generated by a user (which can be a human, automated, or a combination thereof) (Operation 804). As shown in FIG. 8, the NCD desirably cycles through sleep mode, verifying buttons have/have not been pressed and that data packets have not been received from BODs or MODs (during programming mode) (Operations 804-816). It is to be appreciated that this cycling can occur at any given rate, but, desirably is of a short enough duration to detect a depressing of a button or other input from a user. Commonly, the sensing of button depressing can be set for a half second, a second or similar intervals, thereby minimizing processing time while also providing a device which is responsive to user initiated commands. Yet, when automated and/or semi-automated systems are utilized in conjunction with an NCD to command a network, such systems can be desirably configured such that inputs are synchronized to periods when the NCD is “awake” and not “sleeping.”

Further, when a button is not depressed, but, when the NCD is still awake, the device also desirably determines whether any packets have been received (Operation 806). In essence, during programming and/or other conditions, the NCD receives packets from BODs, MODs and/or other devices on the network. Such packets can contain status and/or configuration information useful to the NCD. When such a data packet is received, the NCD proceeds with determining whether such packet is from a BOD (Operation 824). If not, the processing resumes with awaiting button/user inputs, data packets and/or sleep mode (as appropriate) (Operations 802-816). If the received data packet is from a BOD, the NCD then determines whether the packet and the NCD have the same group flags (Operation 826). If not, then the NCD assumes that the packet was not in response to a previously sent command and resumes normal processing (Operations 802-816). If the group flags are the same, the NCD then determines whether the status provided by the BOD is the same as that reflected by the last command (Operation 828). In essence, the NCD determines whether the BOD implemented the last command sent by the NCD. If not, then the last command is resent and processing resumes normal operations (Operation 830). If so, then processing resumes normal operations (Operations 802-816).

Also, (Operation 804) when a button or other “user” input is received by the NCD (Operation 818), processing proceeds with determining whether the button is one to select a group(s) to whom a command is to be transmitted or an actual command (Operations 820-822). In at least one embodiment, group selection occurs prior to command selection. However, in other embodiments, group selection can be fixed, command selection can occur first, or the processing can occur in another order. In any event, upon an identification of a group(s) and a command(s), such command(s) are suitably transmitted by the NCD to the MODs and BODs identified on the network as belonging to the identified group(s).

While various embodiments of the adaptive network of the present invention, devices utilized therein and process flows provided therewith have been described hereinabove, it is to be appreciated that the present invention is not limited to the described embodiments. In general, the present invention encompasses adaptive networks which minimize power consumption by utilizing a compact and efficient data protocol and message processing routines. Such protocols, device construction and routines provide for devices on a network which include programmable product addresses, groups, settings, network identifiers and the like. The foregoing enable devices to be capable of receiving and implementing a wide variety of commands including, but not limited to, slow modes, turn directions, end limits, synchronizing, vane positions, sun control, shock control, wind control, rain control, lighting control and otherwise. Additionally, devices can be programmed with unique product names, provide timer control capabilities, support remote management functions, prohibit unauthorized access or use, support diagnostic and troubleshooting (local and/or remote), such as low battery life in a device, main power lost or others, support climate control functions such as activating heaters or coolers, raising or lowering shades, opening or closing windows and the like, and support many other features and functions desirable in a network of devices utilized in industrial, commercial, residential or other settings.

Further, it is to be appreciated that the data protocols of the present invention can be expanded or contracted. Such data protocols also enable installers of devices, using or compatible with the adaptive network, to utilize pre-programmed, on-site programmed or remotely programmed devices. Software and hardware (such as personal computers, PDAs or others) can be suitably utilized to support such programming, diagnostic and related activities.

As such the various embodiments of the present invention provide an adaptive network for use with a wide variety of devices and is not to be construed as being limited to any specific system, device or process embodiments described herein or shown in the attached drawing figures.

1. An adaptive network comprising:
a main powered device;
a battery powered device and
a network control device;
wherein the main powered device, battery powered device and network control device communicate using a wireless network protocol comprising no more than 11 bytes of data.

2. The adaptive network of claim 1, wherein the wireless network protocol includes a group identifier.

3. The adaptive network of claim 2, wherein the wireless network protocol includes a network identifier.

4. The adaptive network of claim 3, wherein the wireless network protocol includes at least one of an unit identifier and a second group identifier.

5. The adaptive network of claim 4, wherein the second group identifier further comprises at least one of a group flag, a mood identifier, and mask identifier.

6. The adaptive network of claim 1, wherein the main powered device further comprises:
a central processing unit;
a network communications interface;
a device hardware interface; and
a data storage device; wherein the data storage device further comprises a data structure comprising listing of at least one battery powered device with which the main powered device can communicate on the network.

7. The adaptive network of claim 6, wherein the listing further comprises a ranking of devices on the network based upon a connectivity rating.

8. The adaptive network of claim 7 wherein the connectivity rating is determined utilizing a counter algorithm.

9. The adaptive network of claim 8, wherein the counter algorithm further comprises an increasing a connectivity rating for a given device when more status messages are received by the main powered device from the given device exceeds a number of decrement pulses within a given period of time.

10. The adaptive network of claim 9, wherein a decrement pulse is generated approximately once every 200 mSec.

11. The adaptive network of claim 10, wherein the main powered device further comprises a second data structure comprising a connectivity rating between a second main powered device and at least one other device on the network.

12. The adaptive network of claim 11, wherein when the main powered device and the second main powered device both include a connectivity rating with respect to a given battery powered device, the device with the highest connectivity rating is utilized to communicate network messages to the given battery powered device.

13. The adaptive network of claim 1, wherein the main powered device further comprises a network traffic manager which adjusts the message traffic generated by the device on a data channel.

14. The adaptive network of claim 1, wherein the network traffic manager is utilized to determine and establish redundant communications connections between main powered devices, battery powered devices and network control devices.

15. The adaptive network of claim 1, wherein the network and the devices connected thereto are adapted to operate in a duoceive mode wherein a first data channel is utilized to communicate device status messages and a second data channel is utilized to communicate commands between devices.

16. The adaptive network of claim 1, further comprising a repeater.

17. The adaptive network of claim 16, wherein the network control devices utilizes a routing table to determine repeaters to utilize to establish a communications connection between the network control device and at least one of the main powered device and the battery powered device.

18. The adaptive network of claim 1, wherein the network control device is associated with a controller identifier, wherein the controller identifier is used by the main powered device to determine whether the network control device is permitted to control the main powered device.

19. The adaptive network of claim 18, wherein at least one of the main powered device and the battery powered device further comprises a device driver; wherein the device driver is utilized to control the operation of at least one appliance.

20. The adaptive network of claim 19, wherein the at least one appliance further comprises a window covering.
